(19) United States
(12) Patent Application Publication
(10) Pub. No.: US 2002/0006533 A1
(43) Pub. Date: Jan. 17, 2002

(54) Hydrogen gas generator

(76) Inventor: Thomas W. Bergman, Brigham City, UT (US)

Correspondence Address: MALLINCKRODT & MALLINCKRODT, 10 EXCHANGE PLACE, SUITE 510, SALT LAKE CITY, UT, 84111, US

(21) Appl. No.: 09/876,581

(22) Filed: Jun. 6, 2001

Related U.S. Application Data
(60) Provisional application No. 60/209,543, filed on Jun. 6, 2000.

(51) Int. Cl. H01M 8/00; H01M 8/10; B01J 8/08

(52) U.S. Cl. 429/12; 422/232; 429/30

(57) ABSTRACT

A hydrogen gas generator for producing hydrogen gas from the controlled reaction of the alkaline metal sodium contained in a supply tube assembly which is introduced in incremental amounts to water within a pressure tank. Hydrogen produced in the pressure tank, and air bubbled through sodium hydroxide produced in the pressure tank are fed to a fuel cell to produce electricity.

### RELATED APPLICATION

This application claims priority of my co-pending U.S. Provisional Patent Application No. 60/209,543 filed Jun. 6, 2000, the disclosure of which is hereby incorporated by reference.

### SPECIFICATION

### Background of the Invention

1. Field

The invention relates to fuel cells, and more specifically to the production of hydrogen to power fuel cells.

2. State of the Art

There are many people in today's world that are involved in developing alternative energy sources and are currently involved in research to develop efficient, economical sources for the gas hydrogen. While it has been determined from research that petroleum will continue to fill a strong role with the major share of the market in the field of plastics and lubricants, hydrogen will eventually become the sole source for fuel for the 21st century. Petroleum, or hydrocarbons, and byproducts thereof are the source for ninty-six percent of the pollution in the world today. Conversely, hydrogen is recyclable and non-polluting.

Hydrogen as a fuel has been the energy dream of a generation of scientists around the world as a permanent solution for global energy. Why are they looking at hydrogen as the world wide energy solution? Over ninety-eight percent of the matter in the universe is hydrogen. Over two-thirds of the surface of the earth is water, which is two parts of hydrogen for every one part of oxygen. One of the most efficient, effective ways of producing electrical power is in an electrochemical engine, or fuel cell, of which the most effective are powered by hydrogen.

Water, because its components are oxygen and hydrogen is the most dense energy source known to man. Researchers have been trying for years to find the secret to breaking water economically into oxygen to support combustion and hydrogen as the combustible material.

Fuel cells are not new. Their non-polluting qualities and efficient delivery of electrical power have been known for some time. Our Space program depends on fuel cells. But, there are drawbacks to the present method of fueling the fuel cell which have made commercial production for the general public not feasible. There are four major types of fuel cells currently in-use or under development: 1)Proton Exchange Membrane Fuel Cell (PEM); 2)Alkaline Fuel Cell; 3) Solid Oxide Fuel Cell; and 4)Phosphoric Acid Fuel Cell.

Research has identified three major problems that need to be solved to make any of the above fuel cells a reality for use by the general population of the world. The first problem is the delivery of hydrogen to the fuel cell. All fuel cells require hydrogen in one form or another for fuel. The only method that we now have for producing hydrogen is at a large fixed facility which produces compressed hydrogen at about 3,000 pounds per square inch for transportation to the point of consumption. Hydrogen is extremely dangerous in large compressed quantities and very expensive to transport in pressurized cylinders. For instance, to transport hydrogen in pressurized tanks, it requires an eighty-thousand pound eighteen-wheel tractor trailer to transport only six hundred pounds of hydrogen. The second problem is that the most promising fuel cell, the Alkaline Fuel Cell which our space program depends on, begins to lose its ability to produce electrical energy over time if the air supply to it supplying the oxygen for reaction with the hydrogen contains carbon dioxide. The third problem is the fuel cell that most developers are spending their research funds developing, the Proton Exchange Membrane Fuel Cell, is extremely expensive to manufacture and requires frequent and extensive maintenance and cannot be operated at temperatures below freezing without special heating devices. The National Aeronautics and Space Administration (NASA) stopped using PEM fuel cells in the nineteen-sixties and went solely to the Alkaline Fuel Cell for power in its space program. The PEM Fuel Cell was rejected by NASA as it did not function nearly as efficiently as the Alkaline Fuel Cell and was not dependable in space, where most mechanical devices are unmanned and most function without maintenance.

In my co-pending U.S. patent application Ser. No. 09/656,729 filed Sep. 7, 2000 is disclosed more background information about fuel cells, the disclosure of which patent application is hereby incorporated by reference.

There is a need for a hydrogen gas generator for use in a system for producing electrical energy also utilizing a fuel cell, which hydrogen gas generator releases hydrogen from ordinary water to form a non-polluting totally recyclable system.

### SUMMARY OF THE INVENTION

The present invention comprises a hydrogen gas generator, an electrical power generation system, and supply tube assembly.

The hydrogen gas generator is for producing hydrogen gas from the controlled reaction of an alkaline metal contained in a supply tube assembly which is introduced in incremental amounts to water within a contained space. The hydrogen gas generator comprises a sealable pressure tank for holding the water into which the alkaline metal is to be introduced and for holding hydrogen gas produced by the chemical reaction between the alkaline metal and the water. The pressure tank further includes at least one sealable opening for introducing water and outletting hydrogen gas, and an alkaline metal introduction system comprising a pump operably connected to the tank and adapted to feed incremental amounts of the alkaline metal from the supply tube assembly into the pressure tank while the tank remains substantially sealed from ambient air, and without significant loss of hydrogen pressure therein.

The electrical power generation system comprises the hydrogen gas generator as described, and a fuel cell operatively connected to the hydrogen gas generator for receiving hydrogen from the pressure tank and carbon dioxide free air bubbled through sodium hydroxide produced in the pressure tank to produce electricity.

The supply tube assembly is for dispensing incremental amounts of a material contained therein comprising an outer tube made of a substantially resilient material which is substantially non-reactive with one or more alkaline metals. The said outer tube is sealed at one end thereof and sealable at an opposite end thereof. The material comprises an alkaline metal which is substantially non-reactive with the material from which the outer tube is made. The alkaline metal is contained within the outer tube between the ends thereof.

### THE DRAWINGS

FIG. 1, a schematic side elevational view of a hydrogen gas generator according to the present invention; and

FIG. 2, a schematic top plan view of the hydrogen generator.

### DETAILED DESCRIPTION OF THE ILLUSTRATED EMBODIMENTS

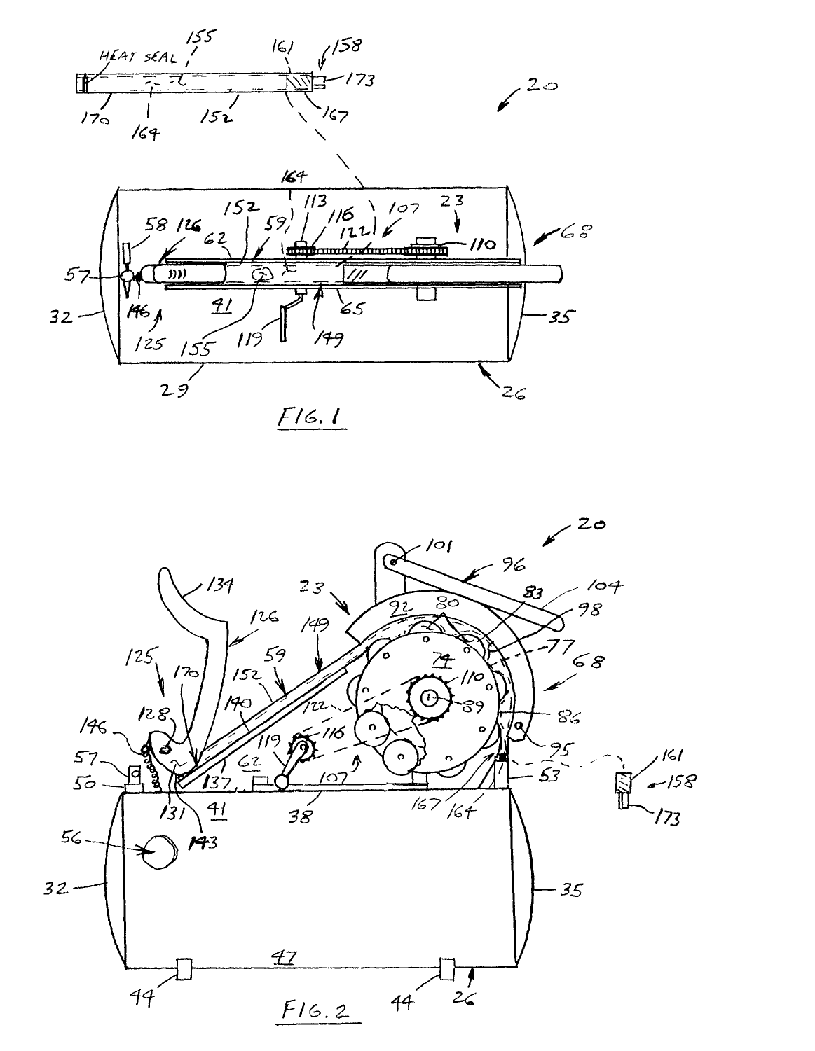

A hydrogen gas generator constructed in accordance with the invention is shown schematically in FIGS. 1 and 2, generally designated 20. Generator 20 comprises an alkaline metal introduction system 23 which is mounted to a pressure tank 26.

Pressure tank 26 is of generally cylindrical configuration, including a cylindrical body 29 and respective end caps 32 and 35. A mounting bracket 38 is affixed to an upper portion 41 of body 29, and a pair of ground-contacting stabilizing brackets 44 are affixed to a lower portion 47 of body 29. Tank 26 further includes a threaded fitting 50 and a tube adapter fitting 53 that are affixed to upper portion 41, both of which communicate with an inner chamber 56 of tank 26. A hose attachable valve 57 with an attached pressure indicator 58 is threadably connected to fitting 50. Alkaline metal introduction system 23 includes a support frame 59 having a pair of vertically disposed parallel plates 62 and 65 which bolt to mounting bracket 38. A plurality of spacers and bolts (not shown) maintain plates 62 and 65 in a spaced parallel relationship.

Alkaline metal introduction system 23 further includes a peristaltic pump 68. Pump 68 comprises a disk 74 having an annular peripheral groove 77 into which a plurality of rollers 80 are rotationally disposed, with respective outer surfaces 83 thereof which extend radially beyond an outermost peripheral surface 86 of disk 74. Disk 74 is rotationally mounted to support frame 59 between plates 62 and 65 by means of a main drive shaft 89 rotationally keyed thereto and supported by plates 62 and 65 on a pair of ball bearings (not shown). Pump 68 further includes semi-arcuate compression ring 92 which is pivotally mounted to support frame 59 between plates 62 and 65 on a pivot pin 95. An inner surface 98 of ring 92 is of a corresponding radius to that formed by the respective outer surfaces 83 of rollers 80. A pump lever 96 is pivotally mounted to support frame 59 between plates 62 and 65 on a pivot pin 101. Pump lever 96 is positioned so as to apply a radially inwardly directed force to ring 92 when a downwardly directed force is applied by hand to a gripping portion 104 of pump lever 96 opposite pivot pin 101.

Alkaline metal introduction system 23 further includes a pump drive assembly 107, which has a driven sprocket 110 keyed to main drive shaft 89 outside of plate 65. A secondary drive shaft 113 is rotationally mounted to support frame 59, being supported by plates 62 and 65 on a pair of ball bearings (not shown). A drive sprocket 116 of smaller diameter than driven sprocket 110, and a hand crank 119 are keyed to secondary drive shaft 113 outside of plate 65. The respective drive and driven sprockets 116 and 110 are rotationally coupled together by a drive chain 122 such that rotation of the hand crank 119 rotates disk 74.

Alkaline metal introduction system 23 further includes a tube retaining assembly 125, which has a tube retention lever 126 pivotally mounted to support frame 59 between plates 62 and 65 on a pivot pin 128. Tube retention lever 126 is positioned so as to apply a much greater inwardly directed force at a cam locking portion 131 adjacent pivot pin 128 when an inwardly directed force is applied by hand to a gripping portion 134 of tube retention lever 126 opposite pivot pin 128. A backing plate 137 of support frame 59 is affixed between 62 and 65, backing plate 137 having a tube support surface 140 which is slightly spaced from a lower locking surface 143 of cam locking portion 131 when tube retention lever 126 is in an unlocking position. Cam locking portion 131 is configured relative to pivot pin 128 so as to retain tube retention lever 126 in a locked position when an object (not shown) is gripped between the respective surfaces 140 and 143 and an inwardly directed force is applied by hand to gripping portion 134. A return spring 146 is connected between cam locking portion 131 and support frame 59 to bias tube retention lever 126 to the unlocking position for ease of inserting the object to be gripped.

The hydrogen gas generator 20 uses supply tube assemblies 149 containing an alkaline metal to fuel the generator 20. Tube assemblies 149 include an outer tube 152 is made of a resilient plastic such as nylon, polypropylene, etc., or made of another such resilient material which is non-reactive with alkaline metals. The outer tube 152 is filled with an alkaline metal 155, being retained within tube 152 by an end seal comprising an end plug 158 having an externally threaded body 161 adapted to tightly thread into an inner bore 164 through outer tube 152 at an open end 167 opposite a sealed end 170 of outer tube 152, to provide an airtight seal to shield the alkaline metal 155 within outer tube 152 from being exposed to the ambient air. The end plug 158 further includes an integral gripping tab 173 which aids in twisting plug 158 during insertion and subsequent removal from outer tube 152 prior to use in generator 20.

The Hydrogen Gas Generator 20 develops hydrogen gas from water through a chemical reaction resulting from combining the alkaline metal 155 with water (not shown) contained within the pressure tank 26. The chemical reaction is controlled by only allowing measured amounts of the alkaline metal 155 to be placed into the water, such as at specific intervals, to maintain a predetermined pressure within tank 26. For example, dispensing alkaline metal 155 into tank 26 of a seven gallon size which holds five gallons of water, a pressure of about 17 PSI is achieved by the produced hydrogen gas.

The hydrogen gas generator 20 is prepared for producing hydrogen gas by first filling tank 26 with water by removing valve 57, adding the appropriate measured amount of water to fill tank 26 to about eighty percent of its capacity, and replacing valve 57. Alternatively, separate filling and/or draining openings and mating plugs or valves (not shown) can be provided on tank 26 to facilitate filling and draining. Next, pump lever 96 is pivoted upwardly releasing compression ring 92 to be pivoted upwardly. Tube retention lever 126 lever is then moved outwardly. One supply tube assembly 149 is assembled to generator 20 following the unscrewing and removal of end plug 158 from open end 167, which is fit over adapter fitting 53 of tank 26, being held in position using a hose clamp (not shown) or other suitable clamping device. Closed end 170 of outer tube 152 is disposed under locking cam portion 131 of tube retention lever 126, outer tube 152 lying along tube support surface 140 of backing plate 137 and over rollers 80 of pump 68. Tube retention lever 126 is then moved inwardly to pinch closed end 170 of outertube 152 between locking cam portion 131 and tube support surface 140 of backing plate 137. This applies about eighty pounds per square inch of pressure to closed end 170 of outer tube 152 providing a secure hold thereof. Next, compression ring 92 is pivoted downwardly onto outer tube 152 and pump lever 96 is pivoted downwardly into contact with compression ring 92.

The hydrogen gas generator 20 is now ready to dispense the alkaline metal 155 contained in the supply tube assembly 149 into the tank 26. This is accomplished by rotating hand crank 119 a predetermined rotational distance while maintaining a predetermined pressure on the gripping portion 104 of pump lever 96. This causes 74 to move rollers 80 against outer tube 152 to force a predetermined quantity or a single “charge” of the alkaline metal 155 contained between rollers 80 through tube adapter fitting 53 into the water contained within the tank 26 based on design factors of the pump 68 such as the size and spacing of the rollers 80. The instant the charge of the alkaline metal 155 is released into the water contained within tank 26, a chemical reaction takes place wherein the alkaline metal 155 combines with the water to chemically release one hydrogen from the two contained in each molecule of the water. The released hydrogen gas is contained in the portion of inner chamber 56 not occupied by the water until it is released for use as an energy source through a hose (not shown) attached to valve 57.

More hydrogen gas can be produced by rotating the hand crank 119 as needed until all the alkaline metal 155 is used up that was contained in the supply tube assembly 149, or until the hydrogen production capability of the water has been depleted. In the former case, the empty supply tube assembly 155 is replaced with a full one. In the latter case, the remaining hydrogen gas is used up or exhausted to atmosphere and the depleted water replaced with fresh water.

The principle that makes the hydrogen gas generator function is the well-known chemical reaction which results from putting an alkaline metal such as sodium into water. The very instant that sodium is released into water an immediate chemical reaction takes place. The sodium combines with one hydrogen and one oxygen releasing one hydrogen (Na plus H₂0 equals NaOH and H).

The NaOH, or sodium hydroxide, part of the chemical reaction can be used to strip carbon dioxide form the ambient air by simply bubbling the air through the sodium hydroxide solution. The H, or hydrogen, part of the reaction can be used to fuel a fuel cell or any device that uses combustible gases for power.

The hydrogen gas generator 20 is an improvement over the existing hydrogen generation devices as it allows the instant explosive nature of the chemical reaction between an alkaline metal and water to be controlled and contain. The by-products of the reaction are hydrogen, and in the case where sodium is the alkaline metal, sodium hydroxide, both being contained in a pressure vessel to be used as they are required. The generator allows the instant explosive nature of the chemical reaction between an alkaline metal and water to be conducted in a safe efficient closed container, wherein the operator is totally insulated from the chemical reaction. The generator allows the instant explosive nature of the chemical reaction between an alkaline metal and water to be conducted on a limited and controlled basis to only produce the amount of hydrogen gas that is required at any given time. The generator allows the instant explosive nature of the chemical reaction between an alkaline metal and water to be conducted on an as-needed basis, so that there is only a safe predetermined amount of hydrogen gas in the pressure vessel at any given moment. The generator allows hydrogen to be transported in its most dense form, that of water, and to be produced at the location that it is required and in the amounts that are required at any given moment. The generator is an improvement over any prior art in the field as it is a unique device that produces the gas hydrogen in a totally safe environment as it is required, in only the quantities that are required at any particular time from water, and it light-weight, compact, and portable.

The hydrogen gas generator solves the three problems described above by using ordinary water which covers most of the earth's surface, and which is the most energy dense medium for transporting hydrogen. Hydrogen can now be supplied at the point that it is needed, as it is needed, by simply chemically breaking down water into hydrogen and oxygen. The consumer fills the tank with water and by the timed and measured addition of a non-polluting chemical, the water molecules each release one of two hydrogen atoms, producing the hydrogen gas needed to fuel a fuel cell such as an alkaline fuel cell. This solves the first problem of transporting hydrogen at high pressure, since hydrogen can be produced from water as it is needed at the point of consumption. The second problem is solved simply by utilizing the by-product of the hydrogen gas generator, which is sodium hydroxide, to clean the incoming air to the fuel cell. Carbon dioxide has a high affinity to combine with sodium hydroxide. The sodium hydroxide is created by the alkaline metal, sodium, combining with the water, creating the perfect scrubber for the stripping of the carbon dioxide from the incoming air to the fuel cell. The solution to the third problem disappears with the solving of the first two problems, as the resulting hydrogen gas generator and the alkaline fuel cell is cost effective, eliminating the need for the expensive Proton Exchange Membrane Fuel Cell Fuel Cell.

The hydrogen gas generator enable industry to manufacture a complete electrical producing plant. The primary electrical plant will consist of an alkaline fuel cell coupled to the hydrogen gas generator that will also, by using the by-product of the chemical reaction, strip the in-coming air to the fuel cell of carbon dioxide. These plants could be sold in different sizes, from one kilowatt to many mega-kilowatts, depending on what is needed by the consumer. A plant of the proper kilowatt size could be used for tools as small as lawn mowers to units large enough to produce energy for whole cities.

Many variations of the hydrogen gas generator are possible while staying within the same inventive concept. For example, while the generator is shown as a portable unit, it could be a larger, fixed unit such as for supplying hydrogen to a fuel cell which generates electricity for a house or an office building. Many different types of tanks can be used, which might be separate from the pump. Other types of pumps can be used which provide incremental depositing of the alkaline metal into the water for a controlled reaction and production of hydrogen gas.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A hydrogen gas generator for producing hydrogen gas from the controlled reaction of an alkaline metal contained in a supply tube assembly which is introduced in incremental amounts to water within a contained space, comprising:
a sealable pressure tank for holding the water into which the alkaline metal is to be introduced and for holding hydrogen gas produced by the chemical reaction between the alkaline metal and the water, said pressure tank which further includes at least one sealable opening for introducing water and outletting hydrogen gas; and
an alkaline metal introduction system comprising a pump operably connected to said tank and adapted to feed incremental amounts of the alkaline metal from the supply tube assembly into said pressure tank while said tank remains substantially sealed from ambient air, without significant loss of hydrogen pressure therein.

2. A hydrogen gas generator according to claim 1, wherein the pump comprises a peristaltic pump mounted to the pressure tank, said peristaltic pump being operatively connectable to the supply tube assembly to incrementally feed alkaline metal contained therein, the supply tube assembly including a sealed end and an open end which is sealingly connectable to an opening of said pressure tank.

3. A hydrogen gas generator according to claim 2, wherein pressure applied to the supply tube assembly by the peristaltic pump is applied by hand.

4. A hydrogen gas generator according to claim 2, wherein the alkaline metal introduction system includes a pump drive assembly operatively connected to the peristaltic pump.

5. A hydrogen gas generator according to claim 3, wherein the pump drive assembly is powered by hand using a hand crank.

6. A hydrogen gas generator according to claim 2, wherein the alkaline metal introduction system further includes a tube retaining assembly which retains the supply tube assembly in a stationary position during operation of the peristaltic pump.

7. A hydrogen gas generator according to claim 6, wherein the tube retaining assembly comprises a hand operated lever having a cam portion which is engageable with the sealed end of the supply tube assembly to retain said sealed end in position using camming action.

8. An electrical power generation system, comprising:
a hydrogen gas generator for producing hydrogen gas from the controlled reaction of an alkaline metal contained in a supply tube assembly which is introduced in incremental amounts to water within a contained space, said hydrogen gas generator which includes a sealable pressure tank for holding the water into which the alkaline metal is to be introduced and for holding hydrogen gas produced by the chemical reaction between the alkaline metal and the water, said pressure tank which further includes at least one sealable opening for introducing water and outletting hydrogen gas, said hydrogen gas generator which further includes an alkaline metal introduction system comprising a pump operably connected to said tank and adapted to feed incremental amounts of the alkaline metal from the supply tube assembly into said pressure tank while said tank remains substantially sealed from ambient air, without significant loss of hydrogen pressure therein; and
a fuel cell operatively connected to said hydrogen gas generator for receiving hydrogen from said pressure tank and carbon dioxide free air bubbled through sodium hydroxide produced in said pressure tank to produce electricity.

9. An electrical power generation system according to claim 8, wherein the fuel cell comprises a proton exchange membrane fuel cell.

10. An electrical power generation system according to claim 8, wherein the fuel cell comprises an alkaline fuel cell.

11. An electrical power generation system according to claim 8, wherein the fuel cell comprises a solid oxide fuel cell.

12. An electrical power generation system according to claim 8, wherein the fuel cell comprises a phosphoric acid fuel cell.

13. A supply tube assembly for use with a peristaltic pump to dispense incremental amounts of a material contained therein, comprising:
an outer tube made of a substantially resilient material which is substantially nonreactive with one or more alkaline metals, said outer tube being sealed at one end thereof and sealable at a removably sealable at an opposite removably sealable end thereof; and
wherein the material comprises an alkaline metal which is substantially non-reactive with said material from which said outer tube is made, said alkaline metal being contained within said outer tube between said ends thereof.

14. A supply tube assembly according to claim 13, wherein the outer tube is made of plastic.

15. A supply tube assembly according to claim 13, wherein the alkaline metal comprises sodium.

16. A supply tube assembly according to claim 13, wherein the sealed end of the outer tube is pinched and heat sealed.

17. A supply tube assembly according to claim 13, wherein the sealable end is sealed using an end plug which removably connects to said sealable end.

18. A supply tube assembly according to claim 17, wherein the end plug includes a body which closely fits within the sealable end of the outer tube.

19. A supply tube assembly according to claim 18, wherein the body of the end plug is externally threaded so as to threadably fit within the sealable end of the outer tube.

20. A supply tube assembly according to claim 19, wherein the end plug includes a gripping tab.
